(19) United States
(12) Patent Application Publication
(10) Pub. No.: US 2026/0237290 A1
(43) Pub. Date: Aug. 13, 2026

(54) COMMUNICATION TERMINAL, COMMUNICATION CONFIGURATION CHANGE METHOD, AND RECORDING MEDIUM

(71) Applicant: NEC Corporation, Minato-ku, Tokyo (JP)

(72) Inventors: Masaaki Takeuchi, Tokyo (JP); Kosei Kobayashi, Tokyo (JP); Masayuki Takekawa, Tokyo (JP)

(73) Assignee: NEC Corporation, Minato-ku, Tokyo (JP)

(21) Appl. No.: 18/730,003

(22) PCT Filed: Mar. 10, 2022
(86) PCT No.: PCT/JP2022/010465

§ 371 Date: Jul. 18, 2024

(51) Int. Cl. G08C 17/02; B60W 60/00; H04N 7/18

(52) U.S. Cl. CPC G08C 17/02; B60W 60/001; H04N 7/185; B60W 2420/403; B60W 2556/45

(57) ABSTRACT

[Problem] To provide a favorable communication function to a mobile body which has a driving mode switching function.

[Solution] This communication terminal is installed in a mobile body capable of switching between at least two or more driving modes comprising a first driving mode for operating on the basis of an operation command received via wireless communication from a predetermined management system, and a second driving mode which differs from the first driving mode. The communication terminal is also equipped with a communication configuration change means for changing the communication configuration with the predetermined management system on the basis of whether or not the driving mode is the first driving mode.

### TECHNICAL FIELD

The present invention relates to a communication terminal, a network control device, a communication configuration change method, a service level change method, and a recording medium.

### BACKGROUND ART

PTL 1 discloses a remote control device that executes appropriate handling processing when an operation state of a control target of remote control by wireless communication changes. Specifically, the remote control device performs processing of switching communication between the control target and the remote control device to a plurality of lines as the handling processing when the operation state of the control target performing the remote control by the wireless communication changes.

### CITATION LIST

### Patent Literature

PTL 1: JP 2016-024613 A

### SUMMARY OF INVENTION

### Technical Problem

In a remote control system described in PTL 1 that constantly performs remote control, when a vehicle to be controlled enters a curve and a vehicle speed is a predetermined value or more during the remote control, the number of lines is multiplexed (refer to paragraphs 0058 to 0059 and FIG. 9).

On the other hand, the remote control requires personnel to be placed in a control center (remote control device side in PTL 1), which causes a problem of cost. For example, when there are a plurality of vehicles to be controlled in PTL 1, it is necessary to place the personnel according to a number of target vehicles and a number of curves in an operation course. For this reason, switching between a driving mode for receiving remote control and other driving modes for a mobile body to be remotely controlled has been studied.

An object of the present invention is to provide a communication terminal, a network control device, a communication configuration change method, a service level change method, and a recording medium that provide a favorable communication function to a mobile body which has the above-described driving mode switching function.

### SOLUTION TO PROBLEM

According to a first point of view, a communication terminal is provided, the communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the communication terminal including communication configuration change means for changing a communication configuration with the predetermined management system based on whether the driving mode is the first driving mode.

According to a second point of view, a network control device is provided, the network control device that provides a communication service to a communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the network control device including receiving means for receiving a driving mode change information from the communication terminal, and service level change means for changing a service level of communication between the predetermined management system and the communication terminal based on the driving mode received from the communication terminal.

According to a third point of view, a communication configuration change method is provided, the communication configuration change method including checking whether a driving mode of a mobile body capable of switching between at least two or more driving modes is a first driving mode, the two or more driving modes including the first driving mode and a second driving mode, the first driving mode for operating based on an operation command received via wireless communication from a predetermined management system, the second driving mode being different from the first driving mode, and changing a communication configuration with the predetermined management system based on the check result.

According to a fourth point of view, a service level change method is provided, the service level change method including, by a network control device that provides a communication service to a communication terminal installed in a mobile body capable of switching between at least two or more driving modes including a first driving mode and a second driving mode, the first driving mode for operating based on an operation command from a predetermined management system, the second driving mode being different from the first driving mode, receiving driving mode change information from the communication terminal, and changing a service level of communication between the predetermined management system and the communication terminal based on the driving mode received from the communication terminal.

According to a fifth aspect, a computer-readable recording medium is provided, the computer-readable recording medium that stores a computer program for implementing the functions of the communication terminal or the network control device described above.

### ADVANTAGEOUS EFFECTS OF INVENTION

According to the present invention, there are provided a communication terminal, a network control device, a communication configuration change method, a service level change method, and a recording medium that provide a favorable communication function to a mobile body which has the above-described driving mode switching function.

### BRIEF DESCRIPTION OF DRAWINGS

FIG. 1 is a diagram illustrating a configuration of one example embodiment of the present invention.

FIG. 2 is a flowchart illustrating operation of one example embodiment of the present invention.

FIG. 3 is a diagram for describing an operation of one example embodiment of the present invention.

FIG. 4 is a diagram illustrating a configuration of a first example embodiment of the present invention.

FIG. 5 is a functional block diagram illustrating a configuration of a communication terminal according to the first example embodiment of the present invention.

FIG. 6 is a diagram for describing the operation of the first example embodiment of the present invention.

FIG. 7 is a diagram illustrating another application example of the first example embodiment of the present invention.

FIG. 8 is a diagram illustrating a configuration of a second example embodiment of the present invention.

FIG. 9 is a diagram for describing an operation of the second example embodiment of the present invention.

FIG. 10 is a diagram illustrating a configuration of a third example embodiment of the present invention.

FIG. 11 is a functional block diagram illustrating a configuration of a network control device according to the third example embodiment of the present invention.

FIG. 12 is a flowchart illustrating an operation of the network control device according to the third example embodiment of the present invention.

FIG. 13 is a diagram illustrating a configuration of a computer that can function as the communication terminal of the present invention.

### EXAMPLE EMBODIMENT

First, an outline of one example embodiment of the present invention will be described with reference to the drawings. The reference numerals in the drawings attached to this outline are attached to each element for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although there are ports and interfaces at connection points of input and output of each block in the drawing, illustration thereof is omitted.

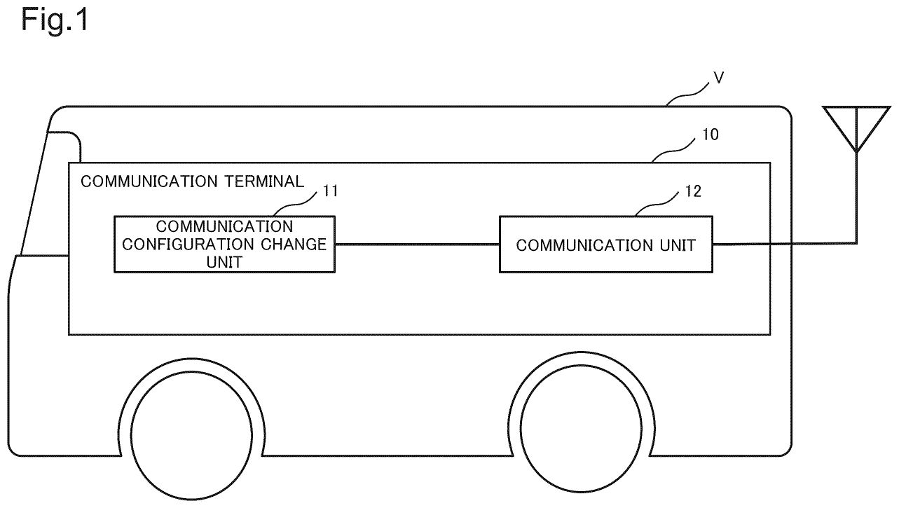

In one example embodiment thereof, as illustrated in FIG. 1, the present invention can be implemented by a communication terminal 10 installed in a mobile body V and including communication means 12 and communication configuration change means 11. More specifically, the mobile body (vehicle) V can switch between at least two or more driving modes including a first driving mode for operating based on an operation command received via wireless communication from a predetermined management system 20, and a second driving mode which differs from the first driving mode. The operation command includes various commands created by the management system 20 based on an image photographed by the mobile body (vehicle). For example, the management system 20 determines a travel environment (curve, road surface (frozen), complex intersection, and poor visibility (pedestrian bridge)) based on the image photographed by the mobile body (vehicle), and generates an operation command according to the travel environment. The management system 20 gives an instruction to change the driving mode according to the travel environment. Further, the management system 20 detects an abnormality of the mobile body (vehicle) from the image photographed by the mobile body (vehicle), generates an operation command according to the abnormality, or gives an instruction to change the driving mode.

The communication configuration change means 11 changes a communication configuration with the management system 20 based on whether the driving mode is the first driving mode. The communication means 12 performs communication with the management system 20 in the changed communication configuration.

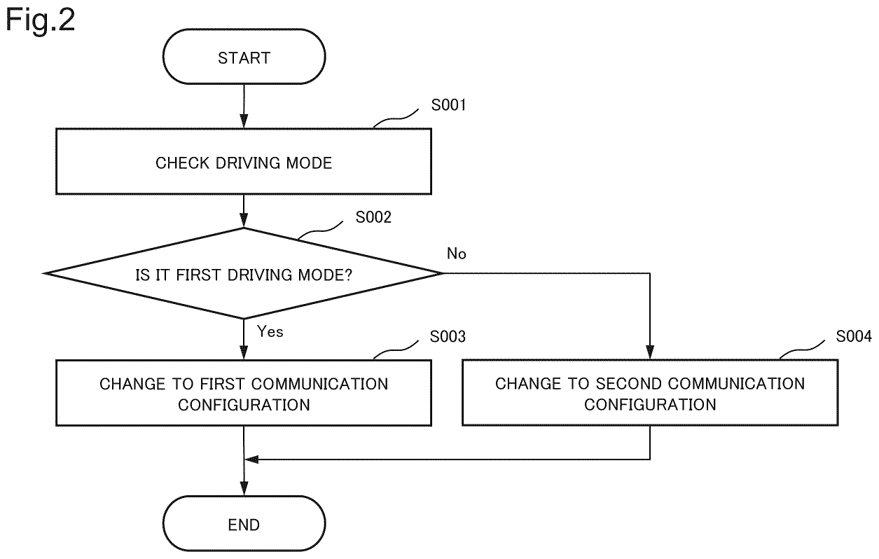

FIG. 2 is a flowchart illustrating the operation of the communication terminal 10. First, the communication terminal 10 checks a driving mode of the mobile body (vehicle) V (step S001). The driving mode of the mobile body (vehicle) V may be determined by the communication terminal 10 from a message exchanged between the mobile body (vehicle) V and a control center 200, or may be determined from a behavior of the mobile body (vehicle) V.

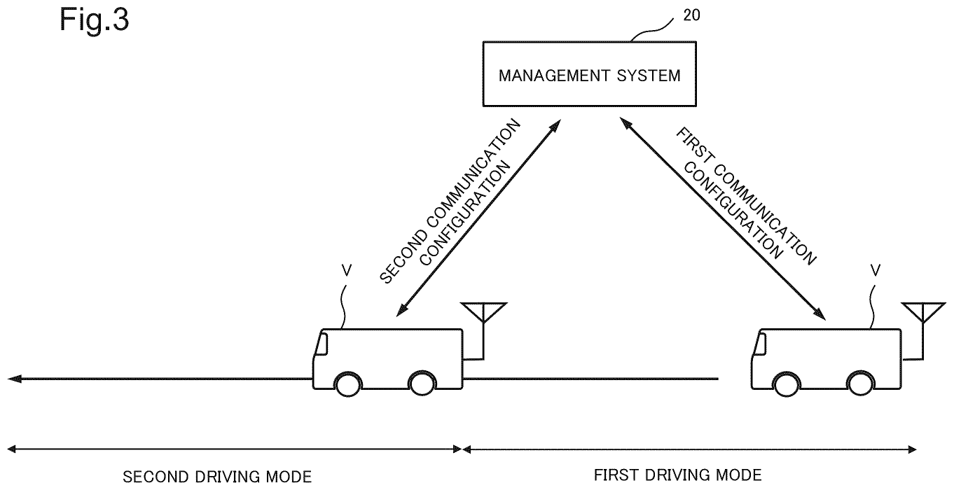

As a result of the checking process, when the driving mode of the mobile body (vehicle) V is a first driving mode, the communication terminal 10 changes the communication configuration with the management system 20 to a first communication configuration (step S003). On the other hand, when the driving mode of the mobile body (vehicle) V is not a first driving mode, the communication terminal 10 changes the communication configuration with the predetermined management system to a second communication configuration (step S004). For example, as illustrated in FIG. 3, when the mobile body (vehicle) V is switched from the first driving mode to the second driving mode while traveling, the communication terminal changes the communication configuration with the management system 20 from the first communication configuration to the second communication configuration.

As described above, it is possible to cause the communication terminal 10 installed in the mobile body having the driving mode switching function to select a communication configuration according to a driving mode. For example, as the first communication configuration, a communication configuration suitable for the first driving mode, that is, a driving mode for operating based on an operation command received via wireless communication from the management system 20 is adopted, whereby the communication in the first driving mode is optimized. On the other hand, in the second driving mode, it is possible to save radio resources by changing to a communication configuration different from the first communication configuration.

In the examples of FIGS. 1 and 3 described above, an example in which the mobile body is the vehicle V has been described, but the mobile body is not limited to the vehicle. For example, the mobile body may be a railway vehicle, an unmanned aerial vehicle (UAV), an automatic guided vehicle, or the like.

### First Example Embodiment

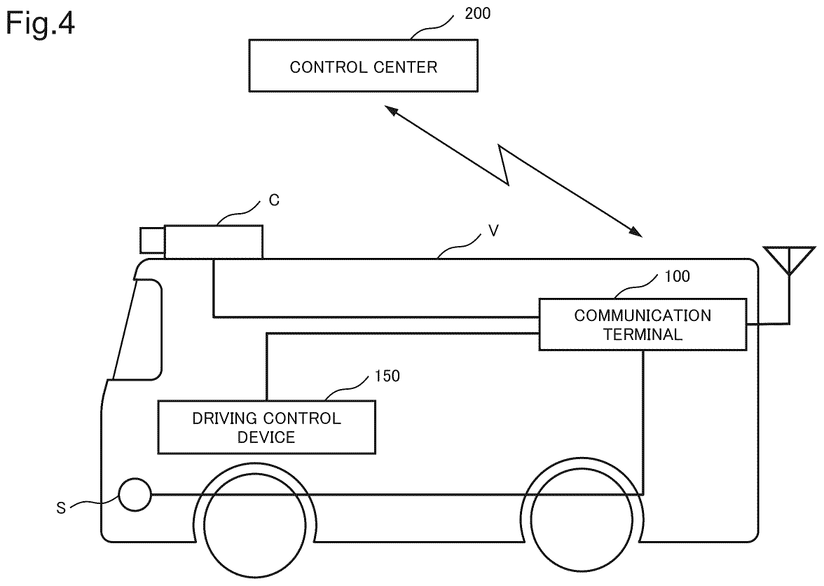

Next, a first example embodiment of the present invention will be described in detail with reference to the drawings. FIG. 4 is a diagram illustrating a configuration of the first example embodiment of the present invention. Referring to FIG. 4, a configuration including a vehicle V on which a driving control device 150 capable of switching a driving mode is installed and a control center 200 that controls the vehicle V is illustrated. The vehicle V includes a camera C, a sensor S, and a communication terminal 100. In the following example embodiment, the control center 200 corresponds to the management system 20 described above.

In the present example embodiment, the vehicle V on which the driving control device 150 is installed will be described as having the following driving modes.

### (1) Remote Monitoring Mode

The control center 200 performs monitoring by the camera C or the sensor S installed in the vehicle. The vehicle V performs automatic driving or manual driving by a driver.

### (2) Remote Control Mode

The control center 200 gives an instruction to the driving control device 150 of the vehicle V while performing monitoring by the camera C or the sensor S installed in the vehicle.

### (3) Remote Operation Mode

The control center 200 performs remote operation of the vehicle V while performing monitoring by the camera C or the sensor S installed in the vehicle.

### (4) Non-Control Mode

The vehicle V performs automatic driving or manual driving by a driver. Monitoring of the control center 200 is not performed. The network connection is also unnecessary.

The remote operation mode described above is an example of a first driving mode for operating based on an operation command received via wireless communication from a predetermined management system. In the first driving mode, an image photographed by the camera installed in the mobile body is transmitted to the predetermined management system, and the operation command is created based on the image. The remote monitoring mode described above is an example of a second driving mode which differs from the first driving mode, and the second driving mode is a driving mode performing either autonomous driving for operating without receiving the operation command from the predetermined management system or manual driving by a crew.

The communication terminal 100 has a communication function for the vehicle V having the above-described driving modes to communicate with the control center 200 according to the above-described driving modes.

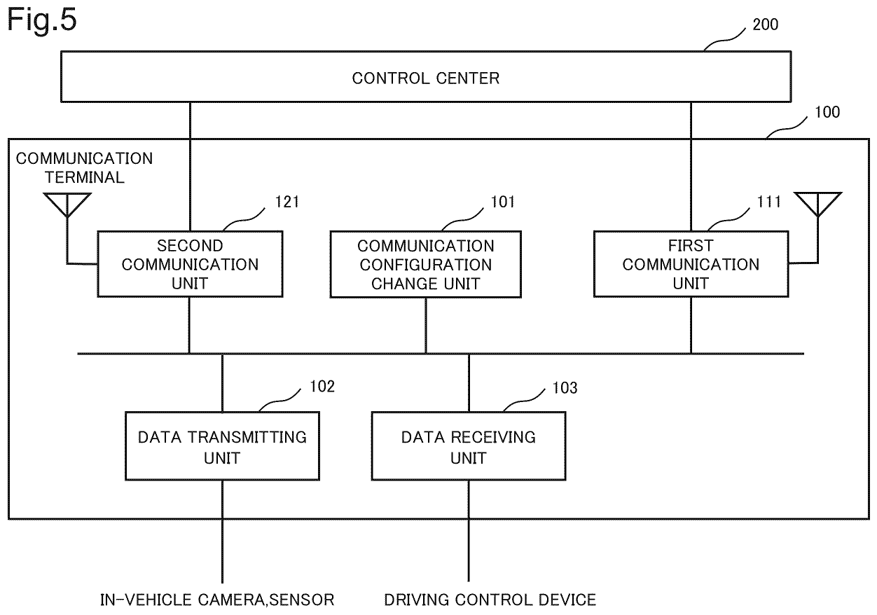

FIG. 5 is a functional block diagram illustrating a configuration of the communication terminal 100 of the present example embodiment. Referring to FIG. 5, configuration including first communication means 111, communication configuration change means 101, second communication means 121, data transmitting means 102, and data receiving means 103 is illustrated.

The first communication means 111 is connected to a first wireless communication network and performs communication. In the present example embodiment, it is assumed that the first wireless communication network is a fifth generation mobile communication system (hereinafter, “5G”).

The second communication means 121 is connected to a second wireless communication network and performs communication. In the present example embodiment, the second wireless communication network is a long term evolution (LTE). Therefore, in the present example embodiment, the first wireless communication network has characteristics such as low delay, large volume (high speed), and multiple simultaneous connection in comparison with the second wireless communication network.

The data transmitting means 102 transmits an image photographed by the camera C and data measured by the sensor S to the control center 200 via either the first communication means 111 or the second communication means 121.

The data receiving means 103 receives, from the control center 200, a driving mode switching instruction, an instruction during the remote control mode, and a operation content in the remote operation mode, and sends the received instruction to the driving control device 150.

The communication configuration change means 101 specifies the driving mode of the vehicle V based on a driving mode change instruction received by the data receiving means 103, and switches between the first communication means 111 and the second communication means 121.

Specifically, the communication configuration change means 101 selects the first communication means 111 and the second communication means 121 as follows.
(1) Remote monitoring mode: select second communication means 121
(2) Remote control mode: select first communication means 111 for transmission and second communication means 121 for reception
(3) Remote operation mode: select first communication means 111

(4) Non-control mode: turn off first communication means 111 and second communication means 121

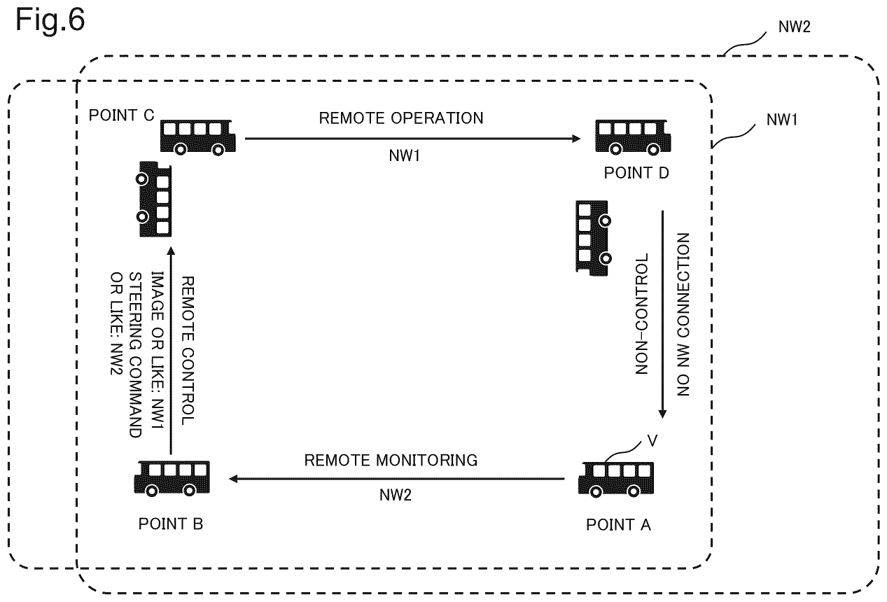

Next, an operation of the present example embodiment will be described in detail with reference to the drawings. FIG. 6 is a diagram for describing the operation of the first example embodiment of the present invention. In the example of FIG. 6, description will be given assuming that a vehicle V having a driving mode switching function goes around from a point A to a point B, a point C, and a point D in this order, and returns to the point A. A description will be given assuming that an area indicated by a broken line NW1 in FIG. 6 is a 5G service providing area and an area indicated by a broken line NW2 is an LTE service providing area.

### (1) Between Point a and Point b

Between the point A and the point B, the vehicle V performs automatic driving due to reasons such as there are few pedestrians or the infrastructure of the road is sufficient. Therefore, in this section, a remote monitoring mode is selected. At this time, the communication configuration change means 101 of the communication terminal 100 selects the second communication means 121 and communicates with the control center 200 using LTE. As described above, since there are few pedestrians and the like and the infrastructure of the road is sufficient between the point A and point B, images and sensor data can be thinned out, and necessary communication can also be performed using LTE.

### (2) Between Point b and Point c

Between the point B and the point C, the vehicle V sends an image and sensor data to the control center 200 and the control center 200 controls the vehicle V due to reasons such as a severe change in traffic volume. Therefore, in this section, a remote control mode is selected. At this time, the communication configuration change means 101 of the communication terminal 100 selects the first communication means 111 and the second communication means 121, transmits data using 5G, and receives an instruction addressed to the driving control device 150 from the control center 200 using LTE. By using 5G for receiving data from the vehicle V, the control center 200 can request and receive a large volume of data from the vehicle V.

### (3) Between Point c and Point d

Between the point C and the point D, a person in charge of the control center 200 directly steers the vehicle V due to reasons such as there are many pedestrians and extreme care is required for driving. Therefore, in this section, a remote operation mode is selected. At this time, the communication configuration change means 101 of the communication terminal 100 selects the first communication means 111 in such a way that data can be transmitted and received to and from the control center 200 using 5G. By using 5G for transmission and reception, the control center 200 can make the most of the characteristics of 5G such as low delay and large volume.

### (4) Between Point d and Point a

The point D to the point A is a section in which the vehicle V is excluded from the control target of the control center 200 due to reasons such as the section is a forwarding section where no passengers get on or there are few pedestrians. In this section, a non-control mode is selected. At this time, the communication configuration change means 101 of the communication terminal 100 turns off both the first communication means 111 and the second communication means 121 and does not perform communication. This makes it possible to save consumption of radio resources in the corresponding section. Of course, in order to prepare for an unexpected situation, the communication configuration change means 101 may select the second communication means 121 in such a way as to be able to transmit and receive the minimum necessary data.

As described above, in the present example embodiment, the communication terminal 100 selects an appropriate wireless network as the communication configuration according to the driving mode of the vehicle V. As a result, the vehicle V and the control center 200 can perform communication necessary for the driving mode.

In the example of FIG. 6 described above, it has been described that the 5G service providing area and the LTE service providing area substantially overlap with each other. However, in an area where both service providing areas do not overlap with each other, an available mobile body communication service may be used.

In the above example, an example has been described in which the communication terminal 100 switches between 5G and LTE. However, the types of wireless networks are not limited to these two, and other wireless networks may also be added in the selection target. For example, when a local 5G base station is installed and available in a certain area, the communication terminal 100 may select the local 5G base station to provide a communication function. In addition to simply switching the wireless network, the communication terminal 100 may estimate or predict a communication quality, a load status (usage status), a radio wave intensity, and the like of the wireless network of a switching destination, and determine whether to perform switching based on the result.

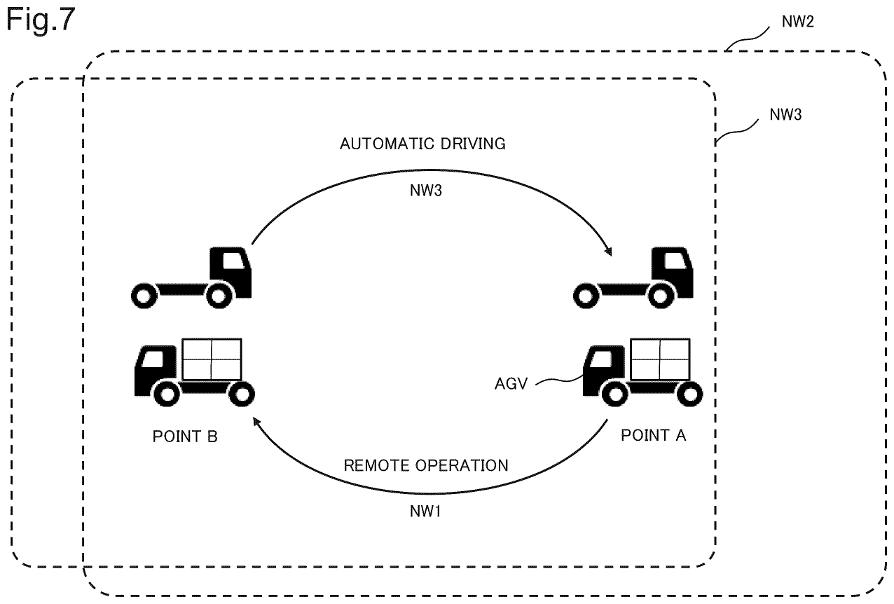

The vehicle V to be controlled is not limited to a bus traveling on a road. For example, as illustrated in FIG. 7, the present invention can also be applied to an automatic guided vehicle AGV traveling in a factory yard. For example, as illustrated in FIG. 7, there is a case where the automatic guided vehicle AGV that conveys a cargo from the point A to the point B and then returns from the point B to the point A operates by remote operation in an outward way and by automatic driving in a return way. Also in this case, 5G (local 5G) may be used in a section in which a driving mode is a remote operation mode, and another wireless network such as Wifi (registered trademark) may be used in a section in which a driving mode is an automatic driving mode.

In the above-described example embodiment, it has been described that the control center 200 performs monitoring by the camera C or the sensor S installed in the vehicle. However, the control center 200 may perform remote operation or remote control of the vehicle by using information of a camera or a sensor on the road in addition to these pieces of information.

### Second Example Embodiment

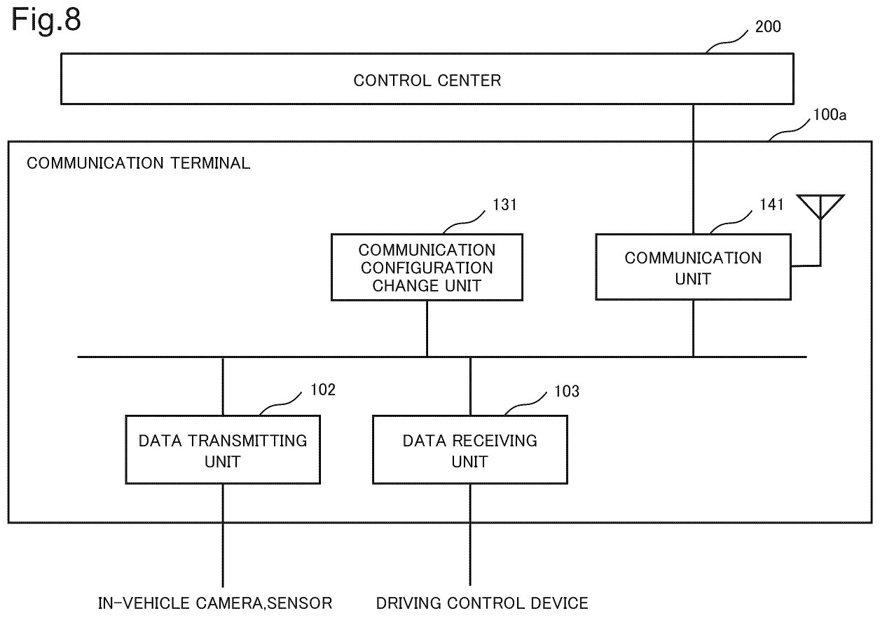

Next, a second example embodiment of the present invention in which the communication terminal performs an operation of changing a priority of communication instead of switching the wireless network will be described in detail with reference to the drawings. FIG. 8 is a functional block diagram illustrating a configuration of a communication terminal 100a according to the second example embodiment of the present invention. Referring to FIG. 8, a configuration including communication means 141, communication configuration change means 101, data transmitting means 102, and data receiving means 103 is illustrated. The difference from the first example embodiment is the functions of the communication means 141 and the communication configuration change means 131. Since other configurations are similar to those of the first example embodiment, description thereof will be omitted, and differences will be mainly described below.

The communication means 141 is connected to a predetermined wireless communication network and performs communication. The predetermined wireless communication network may be either 5G or LTE. When receiving a priority change request from the communication configuration change means 131, the communication means 141 changes the priority of communication by a method of increasing a priority of packets or frames to be transmitted to the control center 200 or a method of requesting a network side to change a priority.

The communication configuration change means 131 specifies a driving mode of the vehicle V based on the driving mode switching instruction received by the data receiving means 103, and requests the communication means 141 to change the priority of communication. Specifically, the communication configuration change means 131 changes the priority as follows.
(1) Remote monitoring mode: priority=low
(2) Remote control mode: priority=high
(3) Remote operation mode: priority=high

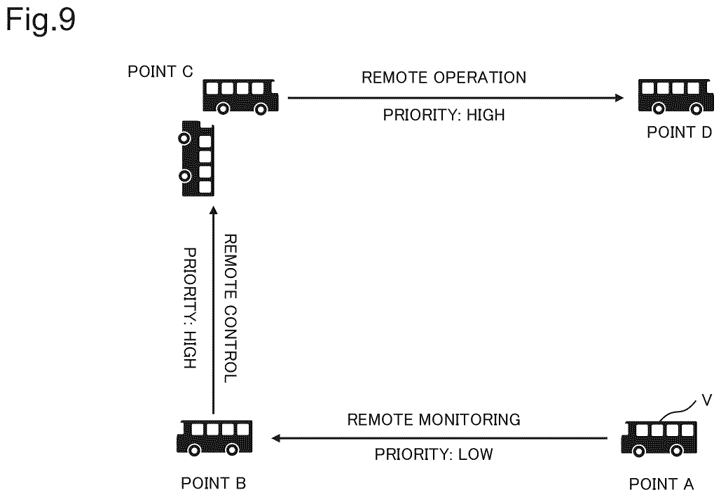

Next, an operation of the present example embodiment will be described in detail with reference to the drawings. FIG. 9 is a diagram for describing the operation of the second example embodiment of the present invention. In the example of FIG. 9, description will be given assuming that a vehicle V having a driving mode switching function goes around from a point A to a point B, a point C, and a point D in this order.

### (1) Between Point a and Point b

As in the first example embodiment, a remote monitoring mode is selected between the point A and the point B. At this time, the communication configuration change means 131 of the communication terminal 100 changes a priority of communication with the control center 200 to low. As in the first example embodiment, since there are few pedestrians and the like and the infrastructure of the road is sufficient between the point A and point B, images and sensor data can be thinned out, and necessary communication can be performed even with a low priority.

### (2) Between Point b and Point c

As in the first example embodiment, a remote control mode is selected between the point B and the point C. At this time, the communication configuration change means 131 of the communication terminal 100 changes a priority of communication with the control center 200 to high. In this remote control mode, since an image with high resolution is transmitted, priority control with a high priority is required. The communication between the control center 200 and the vehicle V in the remote control mode is not required to be as real-time as in the remote operation mode, and thus may have a lower priority than in the remote operation mode. As a change of the priority, in a case where a band can be controlled in addition to the priority control, the communication configuration change means 131 may also request a band. For example, since communication from the vehicle V to the control center 200 transmits a large volume of data such as an image, the communication configuration change means 131 requests a band necessary for these transmissions.

### (3) Between Point c and Point d

As in the first example embodiment, a remote operation mode is selected between the point C and the point D. At this time, the communication configuration change means 131 of the communication terminal 100 changes a priority of communication with the control center 200 to high. In this remote operation mode, transmission of an image with high resolution and exchange of operation operation information with high immediacy are performed, and thus priority control with a high priority is required. Also in this section, the communication configuration change means 131 may request a band. For example, since communication from the vehicle V to the control center 200 transmits a large volume of data such as an image, the communication configuration change means 131 requests a band necessary for these transmissions.

As described above, in the present example embodiment, the communication terminal 100 changes the priority of communication according to the driving mode of the vehicle V. As a result, the vehicle V and the control center 200 can perform communication necessary for the driving mode.

In the example embodiment described above, an example has been described in which the communication terminal 100a changes a priority of communication as a change of a communication configuration, but a method in which the communication terminal 100a changes parameters other than the priority can also be adopted. For example, in a case where the network side is virtually divided into networks having different priorities, an effect equivalent to the change in the priority can be implemented by changing the available virtual network. Instead of the priority, a communication configuration may be changed to a communication configuration in which a redundancy of the line becomes higher, such as a redundancy of the line or a redundancy of the communication terminal at the time of the remote operation mode. These can also be expected to have effects such as reduction in delay, increase in capacity, and improvement in reliability. Instead of changing the priority, a method of aggregating two frequency bands of a frequency band called Sub 6 in 5G and a millimeter wave band to increase the capacity can also be adopted.

### Third Example Embodiment

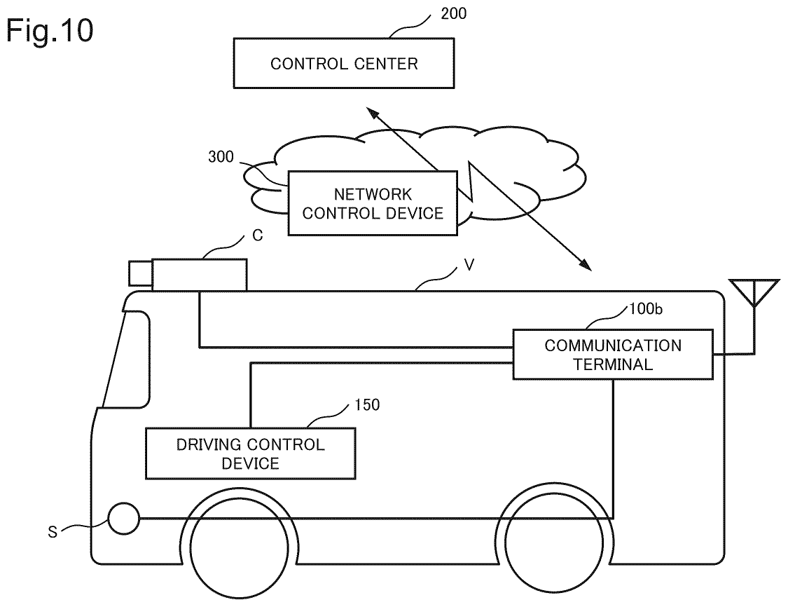

Next, a third example embodiment of the present invention in which a device outside the vehicle has a function of changing the communication configuration will be described in detail with reference to the drawings. FIG. 10 is a diagram illustrating a configuration of the third example embodiment of the present invention. Referring to FIG. 10, a configuration in which a network control device 300 is disposed in a network system between the vehicle V and the control center 200 is illustrated. The difference from the first example embodiment is that the function of changing the communication configuration is omitted on the communication terminal 100b side and is disposed on the network control device 300 side. Since other configurations are similar to those of the first example embodiment, description thereof will be omitted, and differences will be mainly described below.

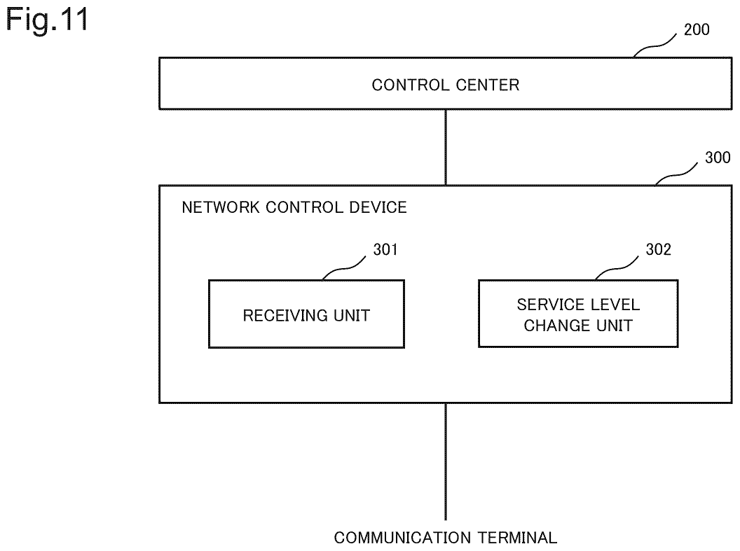

FIG. 11 is a functional block diagram illustrating a configuration of the network control device 300 according to the third example embodiment of the present invention. Referring to FIG. 11, the network control device 300 including receiving means 301 and service level change means 302 is indicated. The network control device 300 may be disposed in any of the networks between the control center 200 and the communication terminal 100b, but may be disposed at an edge of the communication terminal 100b of the network.

The receiving means 301 receives a driving mode switching instruction from the control center 200 or change information such as a driving mode switching request or the like from the communication terminal 100b, and sends them to the service level change means 302.

The service level change means 302 specifies a driving mode of the vehicle V based on the information received from the receiving means 301, and requests a change in a priority of communication between the communication terminal 100 and the control center 200. Specifically, the service level change means 302 changes the priority as follows.
(1) Remote monitoring mode: priority=low
(2) Remote control mode: priority=high
(3) Remote operation mode: priority=high

The network control device as described above can also be implemented by a device that instructs priority control according to the above-described driving mode to a policy control function (PCF) in the 5G network or a policy and charging rule function (PCRF) in the LTE network.

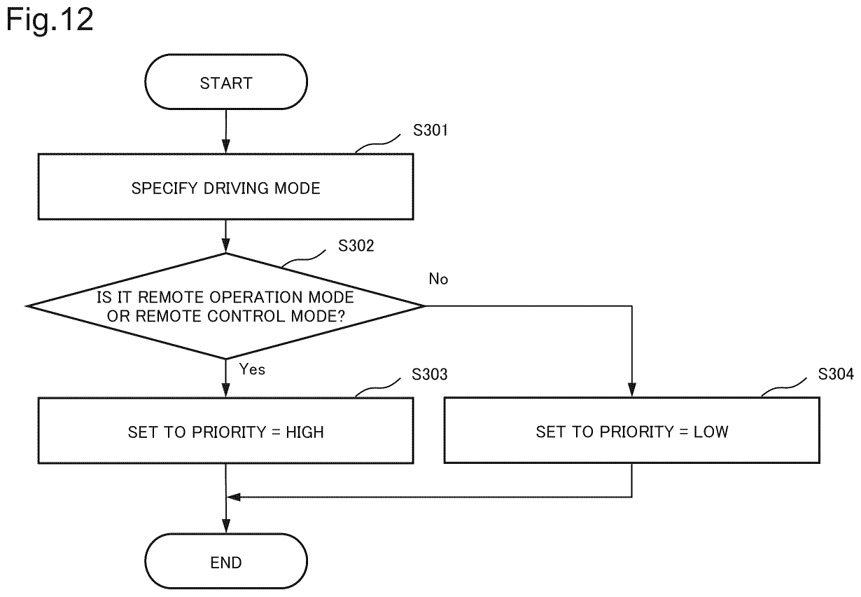

Next, an operation of the present example embodiment will be described in detail with reference to the drawings. FIG. 12 is a flowchart illustrating the operation of the network control device according to the third example embodiment of the present invention. Referring to FIG. 12, first, the network control device 300 checks a driving mode of the mobile body V upon receiving the driving mode switching instruction from the control center 200 or the driving mode switching request from the communication terminal 100b (step S301).

As a result of the checking process, when the driving mode of the mobile body V is a remote operation mode or a remote control mode (Yes in step S302), the network control device 300 sets a priority of communication between the control center 200 and the communication terminal 100b to “high” (step S303).

On the other hand, when the driving mode of the mobile body V is neither a remote operation mode nor a remote control mode (No in step S302), the network control device 300 sets the priority of communication between the control center 200 and the communication terminal 100b to “low” (step S304).

According to the network control device 300 of the third example embodiment operating as described above, it is possible to set an optimum priority according to the driving mode of the vehicle V as in the second example embodiment. Also in the present example embodiment, various modifications can be made similarly to the second example embodiment. For example, in a case where the network side is virtually divided into networks having different priorities, it is possible to implement the same effect as the change of the priority even by changing the virtual network assigned to the communication between the communication terminal 100b and the control center 200.

Although the example embodiments of the present invention have been described above, the present invention is not limited to the above-described example embodiments, and further modifications, substitutions, and adjustments can be made without departing from the basic technical idea of the present invention. For example, the network configuration, the configuration of each element, and the representation form of data illustrated in the drawings are examples for assisting the understanding of the present invention, and are not limited to the configurations illustrated in the drawings.

For example, in each of the above-described example embodiments, an example in which the mobile body is a vehicle has been described, but the mobile body may be a railway vehicle, a UAV, an automatic guided vehicle, or the like. For example, also in a railway vehicle, by applying the present invention, it is possible to appropriately switch between a communication configuration during automatic driving and a communication configuration during remote operation while enabling switching between the automatic driving mode and the remote operation mode.

In the example embodiment described above, the example in which the control center 200 controls one vehicle V has been described, but the present invention is also applicable to a case where the control center 200 controls a plurality of vehicles V. In this case, priorities according to the surrounding status and a processing capability of the control center 200 may be set to the plurality of vehicles V. Then, the control center 200 generates an operation command or changes a driving mode according to the priority of each vehicle V. For example, the control center 200 changes the vehicle V to be prioritized among the plurality of vehicles V to a remote operation mode, and changes the other vehicles V to a remote monitoring mode. At that time, the control center 200 may limit the number of vehicles V to be set to the remote operation mode in accordance with the processing capability of the control center 200.

### Regarding Hardware Configuration

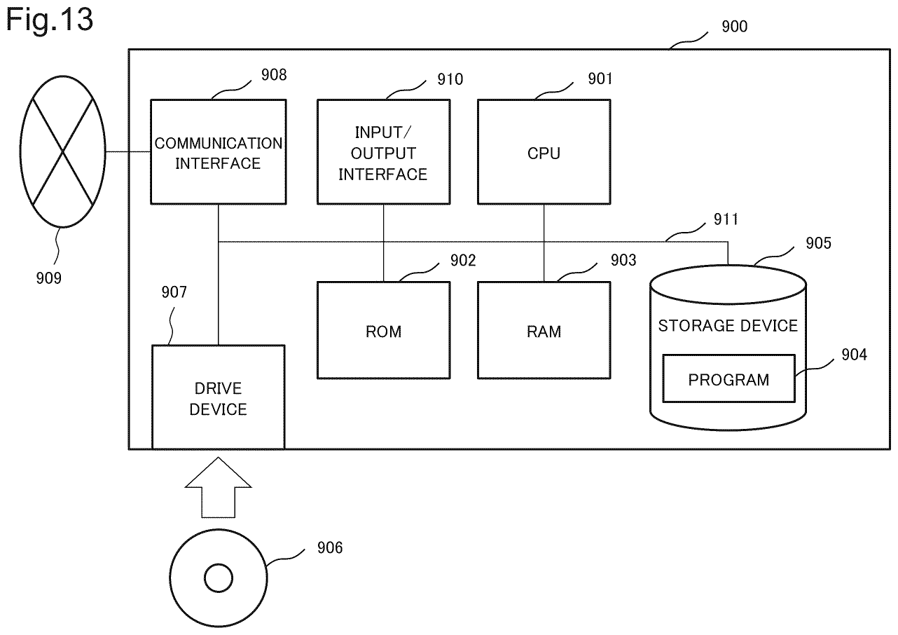

In each example embodiment of the present disclosure, each component of each device indicates a block of a functional unit. A part or all of each component of each device is implemented by, for example, any combination of an information processing device 900 and a program as illustrated in FIG. 13. FIG. 13 is a block diagram illustrating an example of a hardware configuration of the information processing device 900 that implements each component of each device. The information processing device 900 includes the following configuration as an example.
Central processing unit (CPU) 901
Read only memory (ROM) 902
Random access memory (RAM) 903
Program 904 loaded into RAM 903
Storage device 905 storing program 904
Drive device 907 that reads and writes recording medium 906
Communication interface 908 connected to communication network 909
Input/output interface 910 for inputting/outputting data
Bus 911 connecting each component

Each component of each device in each example embodiment is implemented by the CPU 901 acquiring and executing the program 904 for implementing these functions. That is, the CPU 901 of FIG. 13 may execute a vehicle detection program and a determination program to execute update processing of each calculation parameter held in the RAM 903, the storage device 905, or the like. The program 904 for implementing the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906 and the drive device 907 may read the program and supply the program to the CPU 901.

The program 904 can display the processing result including an intermediate state for each stage via a display device as necessary, or can communicate with an outside via the communication interface. The program 904 can be recorded on a computer-readable (non-transitory) recording medium.

There are various modifications of an implementation method of each device. For example, each device may be implemented by any combination of the information processing device 900 and a program separate for each component. A plurality of components included in each device may be implemented by any combination of one information processing device 900 and a program. That is, it can be implemented by a computer program that causes the communication terminal, the network control device, and the processor installed in these devices described in the first to third example embodiments to execute each of the above-described processing using the hardware.

A part or all of each component of each device is implemented by another general-purpose or dedicated circuit, processor, or the like, or a combination thereof. These may be configured by a single chip or may be configured by a plurality of chips connected via a bus.

A part or all of each component of each device may be implemented by a combination of the above-described circuit or the like and a program.

In a case where a part or all of each component of each device is implemented by a plurality of information processing devices, circuits, and the like, the plurality of information processing devices, circuits, and the like may be disposed in a centralized manner or in a distributed manner. For example, the information processing device, the circuit, and the like may be implemented as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a form in which various modifications are made.

A part or all of the above example embodiments may be described as the following supplementary notes, but are not limited to the following.

### Supplementary Note 1

A communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the communication terminal including:
communication configuration change means for changing a communication configuration with the predetermined management system based on whether the driving mode is the first driving mode.

### Supplementary Note 2

The communication terminal described above can be adopted a configuration in the first driving mode, to transmit an image photographed by a camera installed in the mobile body to the predetermined management system, and
the operation command is created based on the image.

### Supplementary Note 3

In the communication terminal described above, the second driving mode may be a driving mode performing either autonomous driving for operating without receiving the operation command from the predetermined management system or manual driving by a crew.

### Supplementary Note 4

The communication terminal described above can be adopted a configuration, in a case of the first driving mode, to change a communication configuration to a communication configuration with less delay than a communication configuration in a case of the second driving mode.

### Supplementary Note 5

The communication terminal described above can be adopted a configuration, in a case of the first driving mode, to change a communication configuration to a communication configuration in which a priority of communication becomes higher than a communication configuration in a case of the second driving mode.

### Supplementary Note 6

The communication terminal described above can be adopted a configuration, in a case of the first driving mode, to change a communication configuration to a communication configuration in which a redundancy of a line becomes higher than a communication configuration in a case of the second driving mode.

### Supplementary Note 7

A network control device that provides a communication service to a communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the network control device including:
receiving means for receiving a driving mode change instruction from the communication terminal or the management system; and
service level change means for changing a service level of communication between the predetermined management system and the communication terminal based on the driving mode received from the communication terminal.

### Supplementary Note 8

A communication configuration change method including: checking whether a driving mode of a mobile body capable of switching between at least two or more driving modes is a first driving mode, the two or more driving modes including the first driving mode and a second driving mode, the first driving mode for operating based on an operation command received via wireless communication from a predetermined management system, the second driving mode being different from the first driving mode; and
changing a communication configuration with the predetermined management system based on the check result.

### Supplementary Note 9

A service level change method including:
by a network system that provides a communication service to a communication terminal installed in a mobile body capable of switching between at least two or more driving modes including a first driving mode and a second driving mode, the first driving mode for operating based on an operation command from a predetermined management system, the second driving mode being different from the first driving mode, receiving driving mode change information from the communication terminal; and
changing a service level of communication between the predetermined management system and the communication terminal based on the driving mode received from the communication terminal.

### Supplementary Note 10

A computer-readable recording medium storing a program for causing a computer to execute a process, the process including: a process of checking whether a driving mode of a mobile body capable of switching between at least two or more driving modes is a first driving mode, the two or more driving modes including the first driving mode and a second driving mode, the first driving mode for operating based on an operation command from a predetermined management system, the second driving mode being different from the first driving mode; and
a process of changing a communication configuration with the predetermined management system based on the check result.

The forms of Supplementary Notes 7 to 10 can be developed to the forms of Supplementary Notes 2 to 6, similarly to Supplementary Note 1.

The disclosures of the above patent documents are incorporated herein by reference, and can be used as a basis or a part of the present invention as necessary. Within the frame of the entire disclosure (including claims) of the present invention, it is possible to change and adjust the example embodiments or examples further based on the basic technical idea. Various combinations or selections (including partial deletions) of various disclosure elements (including each element of each claim, each element of each example embodiment or example, each element of each drawing, and the like) can be made within the frame of the disclosure of the present invention. That is, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise. Furthermore, it is also deemed that the matters disclosed in the documents cited above are included in the matters disclosed in the present application to use a part or all of the matters disclosed in the documents in combination with the matters described in the present specification as a part of the disclosure of the present invention according to the gist of the present invention as necessary.

### REFERENCE SIGNS LIST

10, 100, 100a, 100b Communication terminal
11 Communication configuration change means
12 Communication means
20 Management system
102 Data transmitting means
103 Data receiving means
111 First communication means
121 Second communication means
131 Communication configuration change means
141 Communication means
150 Driving control device
200 Control center
300 Network control device
301 Receiving means
302 Service level change means
900 Information processing device
901 CPU (Central Processing Unit)
902 ROM (Read Only Memory)
903 RAM (Random Access Memory)
904 Program
905 Storage device
906 Recording medium
907 Drive device
908 Communication interface
909 Communication network
910 Input/output interface
911 Bus
AGV Automatic guided vehicle
C Camera
S Sensor
V Vehicle

1. A communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the communication terminal comprising:
communication configuration change means for changing a communication configuration with the predetermined management system based on whether the driving mode is the first driving mode.

2. The communication terminal according to claim 1,
in the first driving mode, transmits an image photographed by a camera installed in the mobile body to the predetermined management system, and wherein the operation command is created based on the image.

3. The communication terminal according to claim 1 or 2, wherein
the second driving mode is a driving mode performing either autonomous driving for operating without receiving the operation command from the predetermined management system or manual driving by a crew.

4. The communication terminal according to any one of claims 1 to 3,
in a case of the first driving mode, changes a communication configuration to a communication configuration with less delay than a communication configuration in a case of the second driving mode.

5. The communication terminal according to any one of claims 1 to 3,
in a case of the first driving mode, changes a communication configuration to a communication configuration in which a priority of communication becomes higher than a communication configuration in a case of the second driving mode.

6. The communication terminal according to any one of claims 1 to 3,
in a case of the first driving mode, changes a communication configuration to a communication configuration in which a redundancy of a line becomes higher than a communication configuration in a case of the second driving mode.

7. A network control device that provides a communication service to a communication terminal installed in a mobile body capable of switching between at least two or more driving modes including a first driving mode and a second driving mode, the first driving mode being a mode for operating based on an operation command received via wireless communication from a predetermined management system, the second driving mode being different from the first driving mode, the network control device comprising:
receiving means for receiving a driving mode change instruction from the communication terminal or the management system; and
service level change means for changing a service level of communication between the predetermined management system and the communication terminal based on the driving mode received from the communication terminal.

8. The network control device according to claim 7,
in the first driving mode, transmits an image photographed by a camera installed in the mobile body to the predetermined management system, and wherein
the operation command is created based on the image.

9. The network control device according to claim 7 or 8, wherein
the second driving mode is a driving mode performing either autonomous driving for operating without receiving the operation command from the predetermined management system or manual driving by a crew.

10. A communication configuration change method comprising:
checking whether a driving mode of a mobile body capable of switching between at least two or more driving modes is a first driving mode, the two or more driving modes including the first driving mode and a second driving mode, the first driving mode for operating based on an operation command received via wireless communication from a predetermined management system, the second driving mode being different from the first driving mode; and
changing a communication configuration with the predetermined management system based on the check result.

11. A service level change method comprising:
by a network system that provides a communication service to a communication terminal installed in a mobile body capable of switching between at least two or more driving modes including a first driving mode and a second driving mode, the first driving mode for operating based on an operation command from a predetermined management system, the second driving mode being different from the first driving mode,
receiving driving mode change information from the communication terminal; and
changing a service level of communication between the predetermined management system and the communication terminal based on the driving mode received from the communication terminal.

12. A computer-readable recording medium storing a program for causing a computer to execute a process, the process comprising:
a process of checking whether a driving mode of a mobile body capable of switching between at least two or more driving modes is a first driving mode, the two or more driving modes including the first driving mode and a second driving mode, the first driving mode for operating based on an operation command from a predetermined management system, the second driving mode being different from the first driving mode; and
a process of changing a communication configuration with the predetermined management system based on the check result.
